(19) United States
(12) Patent Application Publication
(10) Pub. No.: US 2012/0079895 A1
(43) Pub. Date: Apr. 5, 2012

(54) DEVICE AND METHOD FOR GENERATING AND/OR ARRANGING SEQUENCES OF ONE OR MORE FLUID SAMPLES IN A CARRIER FLUID

(75) Inventors: Andreas Schober, Furth (DE); G. Alexander Gross, Babenhausen (DE); Michael Kohler, Golmsdorf (DE)

(73) Assignee: TECHNISCHE UNIVERSITAT ILMENAU, Ilmenau (DE)

(21) Appl. No.: 13/377,632

(22) PCT Filed: Feb. 24, 2010
(86) PCT No.: PCT/EP2010/052334

§ 371 Date: Dec. 12, 2011

(30) Foreign Application Priority Data
Jun. 11, 2009 (DE) 10 2009 025007.7

(51) Int. Cl. G01N 35/08; G01N 21/00

(52) U.S. Cl. 73/864.11; 422/82.05

(57) ABSTRACT

The invention relates to a device for generating and/or arranging sequences of a fluid sample in a carrier fluid. The invention comprises a microchannel having an inlet, an outlet and a nozzle opening therebetween leading into the microchannel. The invention further relates to a delivery unit, which pumps in the carrier fluid using a feed volume flow and suctions off the carrier fluid using a discharge volume flow. In a sample container, the nozzle opening is in contact with the fluid sample. By means of a control unit, the ratio between feed volume flow and discharge volume flow is varied. The cross-section of the nozzle opening is selected such that no carrier medium exits from the nozzle opening when the feed volume flow equals the discharge volume flow and that a fluid sample enters the nozzle opening when the discharge volume flow is greater than the feed volume flow. The invention further relates to a method for generating and/or arranging sequences of a fluid sample in a carrier fluid.

### BACKGROUND OF THE INVENTION

The present invention relates to a device and a method for generating and/or arranging sequences of one or more fluid samples in a carrier fluid which is not miscible with the fluid samples. In this manner, fluid samples, which are received, for example, in microtiter plates or similar containers, can be converted into regular sample sequences to be supplied automatically to subsequent processes. The described device and the method are at the same time suitable for handling said sample sequences in regard to their number, volume quantity, or arrangement in the carrier medium.

In the past years, the processing of samples using the segmented flow method has led to numerous applications. Into this context, various technical solutions and methods for generating and handling segments and segment sequences have been described. The processing of fluid samples in a serial manner allows the advantageous performance of high throughput experiments with various application backgrounds.

Segmented sample flows consist of a fluid sample phase which is embedded as droplets or segments or plugs in carrier fluid (separation phase) which is not miscible with the sample phase, within a fluid conveying component [see also “Digital reaction technology by micro segmented flow-components, concepts and applications”; J. M. Köhler, Th. Henkel, A. Grodrian, Th. Kirner, M. Roth, K. Martin, J. Metze; in Chem. Eng. J. 101 (2004) 201-216.]. The geometric dimensions of the fluid conveying component as well as the sample volume determine the geometry of the segment. Segmented sample flows can be led and handled in a stable manner, without coalescence of individual segments, if the perimeter of the segment formed by the fluidic surface forces fills at least the channel cross section. In the smallest case of a spherical droplet having a diameter of the surrounding channel, the term Ideal Minimal Segment (IMS) is used [see “Chip modules for generation and manipulation of fluid segments for micro serial flow processes”; Th. Henkel, T. Bermig, M. Kielpinski, A. Grodrian, J. Metze, J. M. Köhler; in Chem. Eng. J. 101 (2004) 439-445].

Segment sequences can consist of a plurality of segments, the neighboring segments of which in each case differ only gradually from each other in terms of composition. Corresponding sequences can be produced by the simultaneous dosing of several sample solutions and of the separation phase in a fluidic component. Ismagilov et al. [see also “Reactions in Droplets in Microfluidic Channels”; H. Song, D. L. Chen, R. F. Ismagilov; in Angew. Chem. Int. Ed. 2006, 45, 7336-7356; and “A Microfluidic Approach for Screening Submicroliter Volumes against Multiple Reagents by Using Preformed Arrays of Nanoliter Plugs in a Three-Phase Liquid/Liquid/Gas Flow”; B. Zheng, R. F. Ismagilov; in Angew. Chem. 2005, 117, 2576-2579] describe, for example, a nozzle geometry which makes it possible to combine three fluid flows having different ratios, and generate gradually graded segments by supplying the separation phase.

WO 2004/038363 A2 describes various methods for generating and handling fluid segments. In all the embodiments, all the fluid flows supplied to the component have to be actively pumped, and controlled with precision. In this publication, the use of preformatted sequences (preformed cartridges) is described. However, possibilities for manufacturing are not indicated in greater detail.

DE 103 22 893 A1 describes a method and a device for dosing reaction fluids in fluid compartments embedded in separation medium. Here too, all the fluid flows have to be supplied actively to the component, i.e., pumped. In all the described cases, the starting solutions have to be led by active pumping to the systems from a reservoir container, such as, for example, a filled syringe. Consequently, only a few starting solutions can be converted to segments at a justifiable cost. The background of the applications here involves experiments whose the target parameters are very sensitive to the composition of a few defined samples/ingredients. The addressable diversity of the generated sequence here covers only a defined range in gradually finely adjusted steps.

The conversion of samples from the receivers that are usually used in laboratory practice, such as, for example, microtiter plates, into segment sequences, is not possible using the known devices and methods, or in any case not feasible in a practical manner. Although the dosing of sample segments into a carrier fluid has been basically described in the state of the art, it always requires conveyance devices that actively convey the sample. This approach is ruled out in case of small sample quantities, or a large number of different samples, because the losses would be too great, or the apparatus complexity would be unmanageable. Segment sequences consisting of a series of completely differently composed segments can therefore not be generated efficiently with the known methods.

### SUMMARY OF THE INVENTION

Consequently, one problem of the present invention is to produce a device and a method for converting fluidic samples into preferably regular sample sequences. For this purpose, it should be possible to embed received fluid samples in the form of scalable segments in a carrier fluid, in containers, particularly microtiter plates and the like, without having to take up the fluid sample in a pump device. A partial problem involves enabling the handling of said regular sample sequences, in order to be able to prepare regular, reproducible sample sequences having any desired composition from a large number of fluidic starting samples.

This problem is solved according to the invention by a device according to Claim 1 and a method according to Claim 8. Preferred embodiments of the invention are indicated in the dependent claims.

The device according to the invention is suitable for the gravity-independent conversion of fluid samples into regular sample sequences. For this purpose, a microchannel is provided through which a carrier fluid flows, which can be brought in contact with a fluid sample located, for example, in a container. The microchannel feed line and the microchannel discharge line can be located outside of the respective fluid sample, or they are sealed off with respect to the latter sample, so that fluid sample cannot penetrate through them into the channel. The carrier fluid is not miscible with the fluid samples. The microchannel possesses, in the contact area with the fluid sample, a nozzle opening whose cross section does not exceed the hydrodynamic cross section of the microchannel.

A preferred field of application of the invention involves diversity-based high-throughput experiments, for example, in combinatorial chemistry. For this purpose, the generation and handling of segment sequences from sample sequences having any desired composition from a large number of different starting solutions is necessary. For serial handling, it is particularly important here that the segments can be generated independently of their composition with high regularity both in terms of size and in terms of mutual separation. The present invention allows the generation and/or arrangement of such sequences from one or more fluid samples, by converting samples having a great variety of different compositions into regular segment series. For this purpose, the sequences are formed in a carrier fluid which is not miscible with the fluid samples, and arranged appropriately therein.

As already mentioned, the device according to the invention possesses, for that purpose, a microchannel with a feed line, a discharge line, and a nozzle opening which opens between the feed line and discharge line into the microchannel. Moreover, a conveyance device is provided which pumps the carrier fluid using a feed volume flow V1 via the feed line into the microchannel, and simultaneously suctions it out of the microchannel via the discharge line using a discharge volume flow V2. Finally, at least one sample container containing the fluid sample is present, in which the nozzle opening is in contact with the fluid sample. The shape or position of the container is not important here. The only decisive factor is that the section of the microchannel comprising the nozzle opening can be arranged in the fluid sample to be segmented. This can be achieved, for example, by immersion of the microchannel into the fluid sample, or by connection of a line conveying the fluid sample to the nozzle opening. The fluid sample in the container does not have to be pressurized (no pumping needed), so that one can work with open containers.

The device according to the invention further comprises a control unit which controls the conveyance device, in order to vary the ratio between feed volume flow V1 and discharge volume flow V2. If the nozzle opening is dimensioned appropriately, it is sufficient to set a difference between feed volume flow V1 and discharge volume flow V2 to suction the fluid sample into the carrier fluid, and segment it therein (provided V2>V1), or, if needed, to displace excessive carrier medium between individual segments of the fluid sample from the microchannel through the nozzle outwards, to shorten thus the separation between individual segments (provided V1>V2). The cross section of the nozzle opening can be dimensioned by satisfying the following basic conditions: a) if the feed volume flow is equal to the discharge volume flow (V1=V2), no carrier medium exits from the nozzle opening into the sample container, and no fluid sample enters into the microchannel; b) if the discharge volume flow is greater than the feed volume flow (V2>V1), fluid sample enters into the nozzle, and is embedded as sample segment in the flow of the carrier medium. Thus, on the one hand, the nozzle opening must not be so large that, using an unchanging volume flow, carrier medium flows out of the nozzle. The maximum nozzle opening therefore can be determined taking into account the properties of the carrier fluid (surface tension) and the cross section of the microchannel through which the flow moves. On the other hand, the nozzle opening must be sufficiently large in order to enable the suctioning of fluid into the microchannel, at a chosen difference between the discharge volume flow and the feed volume flow (V2>V1). The capillary pressure generated in the nozzle opening here must not exceed the vapor pressure of the carrier fluid, so that no evaporation in the microchannel occurs.

In practical implementations, the microchannel can have a cross section of preferably 5 μm³ to 3 mm², while the cross section of the nozzle opening is approximately 5 μm² to 2 mm². Examples of suitable carrier fluids are perfluorinated alkanes, for example: perfluorooctane (C8F18) or perfluoromethyldecalin (C11F20).

According to the method of the invention, a fluid sample volume flow V1 is applied to the microchannel feed and a fluid sample volume flow V2 is applied to the microchannel discharge. If the value of the fluid sample volume flow V2 is greater than the value of the fluid sample volume flow V1, the length of the individual sample sequences and the separation between individual sample sequences can be set via the ratio V2/V1. In principle, a nozzle volume flow V3 is always obtained, if V1≠V2, where, in a modified manner, it is also possible to remove portions of fluid samples or carrier fluid from the microchannel via the nozzle. Similarly, it is possible to mix a previously generated regular sample sequences in the microchannel with a second fluid sample which is miscible with the first one.

To carry out the method according to the invention, in a first step, a carrier fluid is supplied via a feed line into a microchannel using a feed volume flow V1, and at the same time suctioned via a discharge line out of the microchannel using a discharge volume flow V2. In a second step, a nozzle opening located in the microchannel between the feed line and the discharge line is introduced into a fluid sample which is not miscible with the carrier medium. In the third step, a difference between feed volume flow V1 and discharge volume flow V2 is set in such a manner that V2>V1. The result of this is that a quantity of the fluid sample is suctioned through the nozzle opening into the microchannel, and, in case of continued operation, several segments of the fluid sample are embedded in the carrier medium which is led in the microchannel. The size (volume) of the individual segments and their separation in the microchannel can be set by varying the ratio between feed and discharge volume flow. The ratio V2:V1 may preferably be in the range 1.05:1 to 20:1.

### BRIEF DESCRIPTION OF THE DRAWINGS

The invention is explained in further detail below in reference to drawings. Here, construction characteristics of the device as well as details of the method are explained in greater detail. The figures show:

FIG. 1 a basic representation of a device according to the invention for generating sequences of a fluid sample in a carrier fluid;

FIG. 2 a diagrammatic representation of four steps in the generation of a sample sequence;

FIG. 3 four embodiment examples for the arrangement of a nozzle opening in a microchannel;

FIG. 4 a diagrammatic representation of the process for generating a segment sequence from different fluid samples;

FIG. 5 a modified embodiment example of the device according to the invention;

FIG. 6 a diagrammatic representation of four different operations of handling segment sequences;

FIG. 7 a diagrammatic representation of a design for measuring a sequence generated in the microchannel;

FIG. 8 a diagram of a measurement signal of a segment frequency, which was generated at V2=−50 μL/min and V1=+25 μL/min in a 0.8 mm ID hose; and

FIG. 9 segment lengths and segment separations for different ratios V2/V1, represented in diagrammatic form.

### DETAILED DESCRIPTION OF THE INVENTION

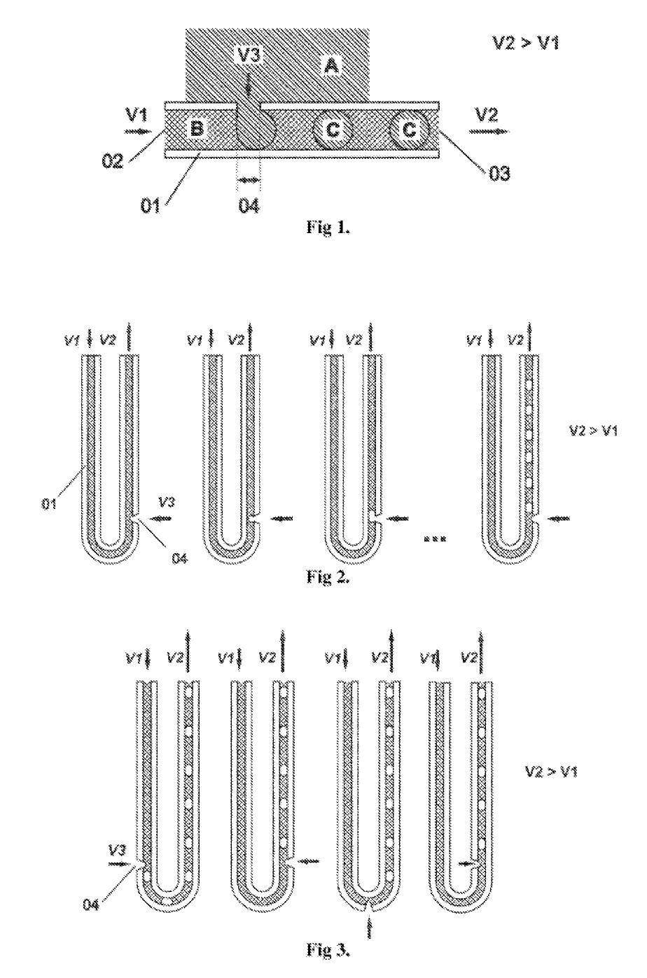

FIG. 1 shows the basic design of a device according to the invention for generating segments and arranging them in a microchannel within a fluid conveying component. For this purpose, a conversion of fluid samples which are arranged in parallel into serially arranged sample sequences is achieved. The device possesses at least one microchannel 01 which, on the input side, presents a feed line 02 and on the outside side a discharge line 03. Moreover, at least one nozzle opening 04 is provided, which provides an access to the microchannel, which is located between feed line 02 and discharge line 03. In the operating state, the nozzle opening 04 is in connection with a quantity of a fluid A (fluid sample), which, if the flow ratios are selected appropriately, can be suctioned through the nozzle opening 04 into the microchannel 01.

The device has a conveyance device (not shown) which is formed, for example, by syringe pumps, and which supplies the microchannel 01, via the feed line 02, with a fluid B (carrier fluid) which is not miscible with fluid A, using a feed volume flow V1. At the same time, the conveyance device removes a discharge volume flow V2 at the discharge line 03 of the microchannel 01. As soon as the discharge volume flow is selected to be greater than the feed volume flow (V1<V2), the resulting difference is compensated by a nozzle volume flow V3, so that fluid sample A flows into the microchannel 01. The result is the formation of regular fluid sample segments C defined by the nozzle geometry and the channel diameter d of the microchannel, and this independently of the fluid sample composition.

The temporal course of the formation of a sample segment and the arrangement of several segments in a sequence are illustrated in FIG. 2.

The geometry of the nozzle opening 04 in the microchannel of the fluid conveying component here must not exceed in terms of cross section the hydrodynamic cross section of the fluid conveying microchannel 01.

As shown in an example in FIG. 3, the relative position of the nozzle opening 04 can vary within the microchannel 01 in the fluid conveying component. In particular, the position of the nozzle opening 04 relative to the level of the fluid sample A is unimportant, as long as one ensures that the nozzle opening 04 is at all times covered or surrounded by the fluid sample A. The transfer of segments of the fluid sample into the carrier fluid occurs independently of gravity.

In the microchannel 01 of the fluid containing component, the feed volume flow (flow rate) V1 is applied in the flow direction of the carrier fluid B in front of the nozzle opening 04, and the discharge volume flow (flow rate) V2 after the nozzle opening 04. For the conversion of the sample solution A (fluid sample) into a serial sequence, the flow rate V2 after the nozzle opening 04 must be greater than the flow rate V1 before the nozzle opening 04. The result is the nozzle volume flow (flow rate) V3 at the nozzle opening 04 into the microchannel 01 of the fluid conveying component. The geometric conditions as well as the surface forces present here lead to the formation of regular fluid sample segments C. Both the segment length and also the mutual separation can be set by varying the flow rate ratio V2/V1. By changing the discharge volume flow V2, the size of the forming segments can be controlled. The frequency of the segments is determined by the flow rate V2. The greater V2 is, the higher the segment formation frequency. If the discharge volume flow V2 is only slightly greater than the feed volume flow V1 (for example, 5-15%), then small spherical segments C form (FIG. 1). When the fluid sample A is suctioned in through the nozzle opening 04, the segment tears off as soon as the fluid sample has reached the wall of the microchannel 01, which faces the nozzle opening. If the discharge volume flow V2 is clearly greater than the feed volume flow V1 (for example, 20-80%), then elongated segments C are formed in the carrier fluid.

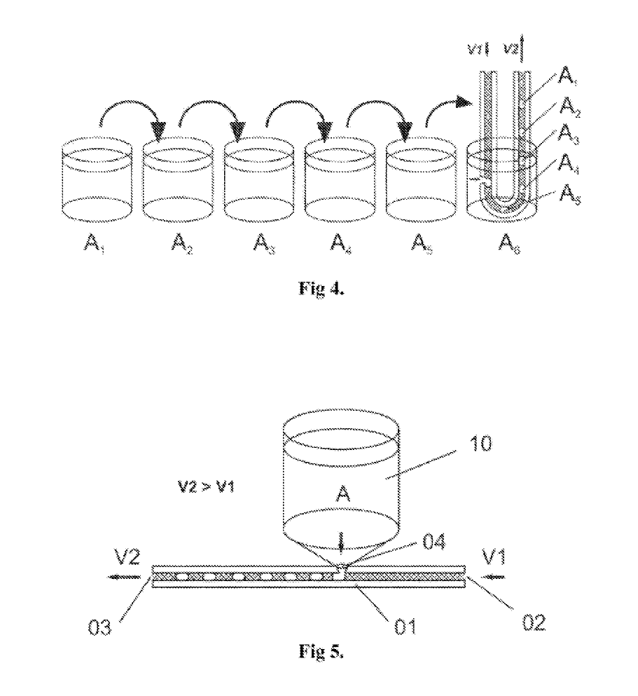

FIG. 4 diagrammatically shows the generation of a sequence from different fluid samples A₁ to A₆. By means of a, for example, computer controlled immersion of the microchannel 01 into different fluid samples A₁ to A₆, which are located in several containers 10, as well as by pulsing the flow rates of V1 and V2, defined segment sequences can be generated, in which the sequential segments or segment packets can differ drastically in their composition. The device according to the invention is therefore particularly suitable for program controlled uptake of various fluid samples which are in a matrix-like arrangement. In the process, the fluid samples which are in a matrix-like arrangement are converted efficiently, for example, from microtiter plates, into a serial sample sequence. This is important in the context of application technology, for example, in the field of miniaturized combinatorial chemistry and also in the field of high-throughput screening.

By means of the device described here and the explained method to operate said device, fluid samples can be made accessible to digital microfluidic processes by a parallel-serial transfer from the usual receivers, for example, microtiter plates. The use of said parallel-serial transfer method produces precise sample sequences of the sample solutions with segment volumes in the μL, nL and pL ranges.

FIG. 5 is an additional embodiment example of the device according to the invention, in a diagrammatic representation, in which the segment generating nozzle 04 is connected directly to the sample container 10 (represented here with the container bottom). Here, the nozzle 04 is integrated directly in the wall of the sample container 10, and the sample solution A is transferred through this connection into the microchannel system 01. By means of this embodiment example, using an appropriate control of the fluid actuator system and by exchanging the fluid sample solution Aᵢ, segment sequences can be generated from different sample solutions.

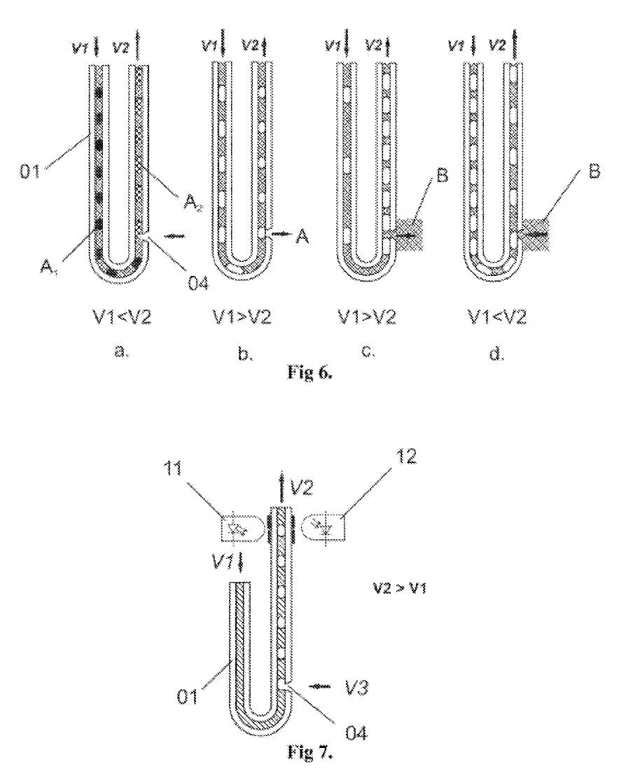

As illustrated in the embodiments shown in FIG. 6, the device according to the invention is also suitable for handling already existing or generated segment sequences. By moving an already generated sequence past the nozzle opening 04 within the microchannel 01, it is possible to produce, for example, mixed segments from different sample solutions, if the above described process conditions (V1<V2) are maintained (FIG. 6a). Here, the mixing ratio can be set by applying different volume flows V1 and V2. However, by applying the reversed flow rate conditions (V2<V1), it is also possible to reduce segments in a sequence in terms of volume (FIG. 6b). If, under these flow conditions, a segment flows past the nozzle opening 04, a portion of the fluid sample is pushed outwards from the nozzle, so that the resulting volume flow in the microchannel 01 is reduced. The separation phase (carrier fluid) here does not exit through the nozzle opening 04, because the surface tension between the nonmiscible phases prevents this.

If, as external fluid (located outside of the microchannel 01, and applied on the nozzle opening 04 on the outside), the carrier fluid B is used instead of a fluid sample A, the separation of the segments in the microchannel 01 can be manipulated, without changing the sample segments. In this manner, it is possible to reduce, in a sequence, the separation between individual segments, by setting V1>V2 (FIG. 6c), or increase it, by setting V1<V2 (FIG. 6d).

In FIG. 7, an experimental setup is shown for determining the sequence properties, for example, the segment lengths and segment separations. For this purpose, photometric micro throughflow detector is mounted directly on the transparent microchannel 01 (hose), wherein, on the illumination side, an LED 11 is used as light source, and on the detection side a photodiode 12. Both diodes are mounted with the help of plates directly on the hose 01. The measurement location formed in this manner makes it possible to detect sample segments both on the basis of their different refractive indexes in comparison to the separation phase (carrier fluid) and also on the basis of different absorption properties.

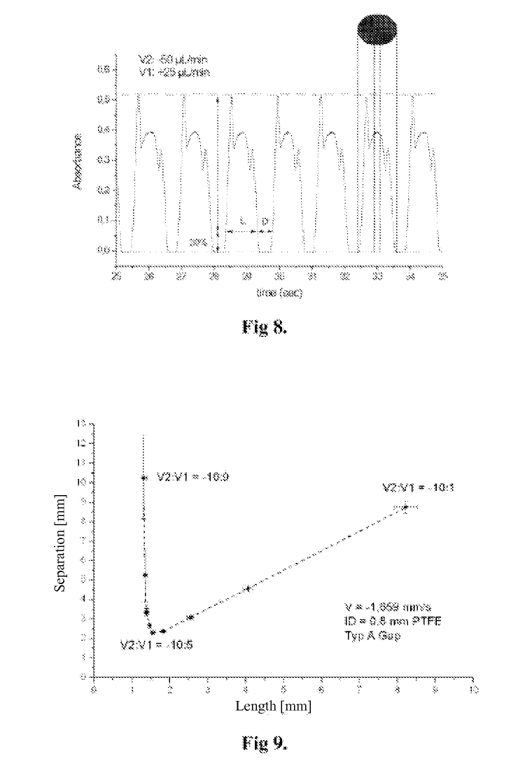

In FIG. 8, an example of the detected signals is shown, in an exemplary manner, which signals are obtained with the above-mentioned throughflow detector arrangement, under the following conditions. For the determination of the sequence quality, a sample solution of ethanol was stained with a dye (crystal violet), and converted with the aid of the presented device into segments. As separation phase (carrier fluid), a perfluorinated alkane was used (perfluoromethyldecalin). The evaluation of the segment courses represented in FIG. 8 at different flow rate ratios V2/V1 is represented as a diagram in FIG. 9; it shows the high reproducibility of the generated segments, and the quality of the segment sequences generated with the method according to the device.

1. A device for generating and/or arranging sequences of one or more fluid samples (A) in a carrier fluid (B) which is not miscible with the fluid samples (A), comprising:
a microchannel with a feed line, a discharge line, and a nozzle opening which opens between feed line and discharge line into the microchannel;
a conveyance device which pumps the carrier fluid (B) using a feed volume flow (V1) via the feed line into the microchannel; and
a sample container containing the fluid sample (A);
characterized in that the conveyance device suctions the carrier fluid (B) out of the microchannel via the discharge line using a discharge volume flow (V2); in that, in the sample container the nozzle opening is in contact with the fluid sample (A); in that the device further comprises a control unit which controls the conveyance direction, in order to vary the ratio between feed volume flow (V1) and discharge volume flow (V2), and in that the cross section of the nozzle opening satisfies the following conditions:
a) if the feed volume flow is equal to the discharge volume flow (V1=V2), no carrier medium (B) exits from the nozzle opening into the sample container, and no fluid sample (A) enters into the microchannel,
b) if the discharge volume flow is greater than the feed volume flow (V2>V1), fluid sample (A) enters into the nozzle opening, so that it is embedded as sample segment (C) in the flow of the carrier medium (B).

2. The device according to claim 1, wherein the device comprises a positioning unit through which the nozzle opening of the microchannel can be introduced into different sample containers.

3. The device according to claim 2, wherein the several sample containers are in a matrix-like arrangement, particularly in the form of a microtiter plate.

4. The device according to claim 1, wherein the nozzle opening is designed as a V-shaped cut into a microchannel formed by a hose.

5. The device according to claim 1, wherein the conveyance devices are designed as syringe pumps.

6. The device according to claim 1, wherein the sample container presents an opening under the level of the fluid sample (A), to which opening the nozzle opening of the microchannel is connected.

7. The device according to claim 1, wherein the microchannel presents, in the flow direction after the nozzle opening, a transparent area on which an optical sensor is arranged, which detects the segments (C) of the fluid sample that are introduced in the carrier fluid (B).

8. A method for the generation and/or arrangement of sequences of one or more fluid samples (A) in a carrier fluid (B) which is not miscible with the fluid samples (A), comprising the following steps:
supplying the carrier fluid (B) via a feed line into a microchannel using a feed volume flow (V1);
simultaneous suctioning the carrier fluid (B) via a discharge line out of the microchannel using a discharge volume flow (V2);
positioning a nozzle opening which is located in the microchannel between the feed line and the discharge line, in a container which contains the fluid sample (A); and
setting a difference between feed volume flow (V1) and discharge volume flow (V2), and thus generating of a nozzle volume flow (V3) through the nozzle opening, the amount of which corresponds to the set difference.

9. The method according to claim 8, wherein the fluid sample (A) is filled into the container the discharge volume flow is set to be greater than the feed volume flow (V2>V1), so that a quantity of the fluid sample (A) is suctioned into the microchannel via the nozzle opening using a nozzle volume flow (V3), and several segments (C) of fluid sample (A) are embedded in the carrier medium (B) which is led in the microchannel, for the generation of a sequence.

10. The method according to claim 8, wherein the nozzle opening of the microchannel is introduced successively into different fluid samples (A₁ . . . A₆).

11. The method according to claim 8, wherein the previously generated sequence is again supplied to the microchannel via the feed line, while the nozzle opening is introduced into a second fluid sample, in order to suction, by resetting a difference between feed volume flow V1 and discharge volume flow V2 with V2>V1, quantities of the second fluid sample through the nozzle opening into the microchannel, and embed several segments of the second fluid sample (A₂) in the carrier medium (B) which is led in the microchannel, or mix them with the segments of the first fluid sample (A₁).

12. The method according to claim 8, further comprising the previously generated sequence is again supplied to the microchannel via the feed line, while the nozzle opening is introduced into a quantity of carrier medium (B), wherein the discharge volume flow (V2) is set to be greater than the feed volume flow (V1), in order to suction, between the sequences of the fluid sample (A), additional carrier medium (B) through the nozzle opening, into the microchannel, or the discharge volume flow (V2) is set to be smaller than the feed volume flow (V1), in order to push portions of the carrier medium (B) located between the sequences of the fluid sample (A) in the microchannel, through the nozzle opening.

13. The method according to claim 8, further comprising when setting the difference between feed volume (V1) and discharge volume flow (V2), a ratio V2:V1 in the range from 1.05:1 to 20:1 is selected.
